(19) United States
(12) Patent Application Publication
(10) Pub. No.: US 2017/0294002 A1
(43) Pub. Date: Oct. 12, 2017

(54) SYSTEMS AND METHODS FOR ADJUSTING AN IMAGE

(71) Applicant: QUALCOMM Incorporated, San Diego, CA (US)

(72) Inventors: Chao Jia, San Diego, CA (US); Ramin Rezaiifar, Del Mar, CA (US)

(21) Appl. No.: 15/177,013

(22) Filed: Jun. 8, 2016

Related U.S. Application Data
(60) Provisional application No. 62/319,734, filed on Apr. 7, 2016.

(51) Int. Cl. G06T 5/00; G06K 9/62; G06K 9/46

(52) U.S. Cl. CPC G06T 5/006; G06K 9/4604; G06K 9/6218; G06K 9/6219

(57) ABSTRACT

A method for adjusting an image by an electronic device is described. The method includes detecting line segments in a single image. The method also includes clustering the line segments to produce a set of vanishing points. The method further includes determining a combination of a focal length and vanishing points corresponding to principal axes of a primary scene coordinate system from the set of vanishing points and a set of focal lengths based on an orthogonality constraint. The method additionally includes adjusting the single image based on the combination of the focal length and vanishing points to produce a perspective-adjusted image.

### RELATED APPLICATION

This application is related to and claims priority to U.S. Provisional Patent Application Ser. No. 62/319,734, filed Apr. 7, 2016, for “SYSTEMS AND METHODS FOR ADJUSTING AN IMAGE.”

### FIELD OF DISCLOSURE

The present disclosure relates generally to electronic devices. More specifically, the present disclosure relates to systems and methods for adjusting an image.

### BACKGROUND

Some electronic devices (e.g., cameras, video camcorders, digital cameras, cellular phones, smart phones, computers, televisions, automobiles, personal cameras, action cameras, surveillance cameras, mounted cameras, connected cameras, robots, drones, smart applications, healthcare equipment, set-top boxes, etc.) capture and/or utilize images. For example, a smartphone may capture and/or process still and/or video images. Processing images may demand a relatively large amount of time, processing, memory and energy resources. The resources demanded may vary in accordance with the complexity of the processing.

In some cases, captured images may appear to be low quality. For example, captured images may not appear to be high quality. This may occur when an amateur photographer uses an electronic device to capture an image. As can be observed from this discussion, systems and methods that improve image processing may be beneficial.

### SUMMARY

A method for adjusting an image by an electronic device is described. The method includes detecting line segments in a single image. The method also includes clustering the line segments to produce a set of vanishing points. The method further includes determining a combination of a focal length and vanishing points corresponding to principal axes of a primary scene coordinate system from the set of vanishing points and a set of focal lengths based on an orthogonality constraint. The method additionally includes adjusting the single image based on the combination of the focal length and vanishing points to produce a perspective-adjusted image.

The method may include refining the focal length based on the determined vanishing points based on the orthogonality constraint. The method may include refining coordinates of at least one vanishing point based on least-squares fitting.

Determining the combination of the focal length and vanishing points may include selecting, from the set of vanishing points, a set of vanishing points with a largest number of corresponding line segments that satisfies the orthogonality constraint. Determining the combination of the focal length and vanishing points may include evaluating possible focal length values within a canonical range.

The method may include estimating a rotation matrix based on the determined vanishing points. Estimating the rotation matrix may include determining a permutation of rotation matrix columns that has a determinant of 1 and a minimum rotation angle.

Clustering the line segments may include initializing a cluster for each of the line segments. Clustering the line segments may also include iteratively merging the clusters. Each of the clusters may be represented as a Boolean set. Merging the clusters may include merging clusters with a smallest Jaccard distance.

An electronic device for adjusting an image is also described. The electronic device includes a processor. The processor is configured to detect line segments in a single image. The processor is also configured to cluster the line segments to produce a set of vanishing points. The processor is further configured to determine a combination of a focal length and vanishing points corresponding to principal axes of a primary scene coordinate system from the set of vanishing points and a set of focal lengths based on an orthogonality constraint. The processor is additionally configured to adjust the single image based on the combination of the focal length and vanishing points to produce a perspective-adjusted image.

An apparatus for adjusting an image is also described. The apparatus includes means for detecting line segments in a single image. The apparatus also includes means for clustering the line segments to produce a set of vanishing points. The apparatus further includes means for determining a combination of a focal length and vanishing points corresponding to principal axes of a primary scene coordinate system from the set of vanishing points and a set of focal lengths based on an orthogonality constraint. The apparatus additionally includes means for adjusting the single image based on the combination of the focal length and vanishing points to produce a perspective-adjusted image.

A computer-program product for adjusting an image is also described. The computer-program product may include a non-transitory computer-readable medium with instructions thereon. The instructions include code for causing an electronic device to detect line segments in a single image. The instructions also include code for causing the electronic device to cluster the line segments to produce a set of vanishing points. The instructions further include code for causing the electronic device to determine a combination of a focal length and vanishing points corresponding to principal axes of a primary scene coordinate system from the set of vanishing points and a set of focal lengths based on an orthogonality constraint. The instructions additionally include code for causing the electronic device to adjust the single image based on the combination of the focal length and vanishing points to produce a perspective-adjusted image.

### BRIEF DESCRIPTION OF THE DRAWINGS

FIG. 1 is a block diagram illustrating one example of an electronic device in which systems and methods for adjusting an image may be implemented;

FIG. 2 is a flow diagram illustrating one configuration of a method for adjusting an image;

FIG. 3 is a block diagram illustrating examples of components and/or elements that may be implemented in accordance with the systems and methods disclosed herein;

FIG. 4 is a flow diagram illustrating a more specific configuration of a method for adjusting an image;

FIG. 5 is a flow diagram illustrating one configuration of a method for clustering line segments;

FIG. 6 is a flow diagram illustrating a more specific configuration of a method for clustering line segments;

FIG. 7 is a diagram illustrating an example of measuring consistency between a line segment and a vanishing point;

FIG. 8 is a flow diagram illustrating one configuration of a method for estimating a camera orientation and/or adjusting an image;

FIG. 9 is a diagram illustrating examples of image adjustment functions;

FIG. 10 illustrates an example of image adjustment in accordance with the systems and methods disclosed herein;

FIG. 11 illustrates another example of image adjustment in accordance with the systems and methods disclosed herein;

FIG. 12 illustrates another example of image adjustment in accordance with the systems and methods disclosed herein;

FIG. 13 illustrates another example of image adjustment in accordance with the systems and methods disclosed herein;

FIG. 14 illustrates another example of image adjustment in accordance with the systems and methods disclosed herein; and

FIG. 15 illustrates certain components that may be included within an electronic device configured to implement various configurations of the systems and methods disclosed herein.

### DETAILED DESCRIPTION

The systems and methods disclosed herein may relate to adjusting (e.g., straightening) an image. For example, the systems and methods disclosed herein may enable detecting and compensating for 3D rotation between a camera and a scene.

In some images, the scene and/or object(s) in the image may appear tilted. When photographing tall buildings, for example, one issue that the users often encounter is the keystone effect. The keystone effect may result from the angle at which the photograph is captured. Since the camera is tilted away from the building, with the top of the lens being further away from the building than the bottom of the lens, the bottom of the building often looks wider than the top.

Besides the keystone effect, in amateur-quality photos the dominant scene structure and the camera lens may be at different orientation angles for many reasons. For example, the camera may be oriented with a slight unintended tilt during capture, which may cause the photos to appear crooked. Straightening the photos by compensating for the rotation between camera and the scene may be beneficial for producing high-quality photos.

Some photo editors require the users to enter the needed transformation to straighten the photos. Moreover, some editors may only be able to apply 2D in-plane rotation to the photos, making them incapable of correcting the keystone effect that is caused by camera tilt. It would be beneficial to automatically straighten an image by perspective correction. The systems and methods disclosed herein are able to automatically detect and compensate for 3D rotation with full degrees of freedom between the camera and the scene. This may be accomplished without any user interaction (e.g., without entering a transform) or any prior knowledge about the camera.

To estimate the 3D rotation, line segments may be detected. The line segments may be clustered so that each cluster corresponds to a single direction in the 3D space. The line segment clustering may be implemented using different approaches such as expectation-maximization and/or J-Linkage clustering. The line segments in each cluster may intersect at a single vanishing point (by definition, for example). A set of vanishing points may be computed from the clusters of line segments using a robust fitting approach (e.g., least-squares fitting).

The sets of all detected vanishing points may be used to search for a triplet (or pair if a triplet is not observable, for example) that corresponds to the x, y, and z directions of the primary 3D scene coordinate system. Such triplet (or pair) of vanishing points may satisfy an orthogonality constraint: the vanishing points may be orthogonal to each other after being back-projected to three-dimensional (3D) space. In some approaches, the back-projection of the camera may utilize pre-calibration to get the value of focal length. In some configurations of the systems and methods disclosed herein, pre-calibration may be avoided by performing a grid search on a canonical range of the focal length. Among all possible triplets (or pairs) of vanishing points that satisfy the orthogonality constraint, one may be selected that has the largest number of supported line segments.

With the selected vanishing points, a finer estimate of the camera focal length may be obtained using the orthogonality constraint. The selected vanishing points may be utilized to construct the 3D rotation matrix by using the permutation that minimizes the rotation angle. To straighten the image, the estimated focal length and 3D rotation may be utilized to align camera lens with the scene, which may be implemented by a perspective transform.

Some advantages of the systems and methods disclosed herein may include not requiring user input, pre-calibration of the camera, or any camera motion estimation from other sensors (e.g., inertial sensors). The systems and methods may be able to automatically compensate for 3D rotation with full degrees of freedom between the camera and the scene.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

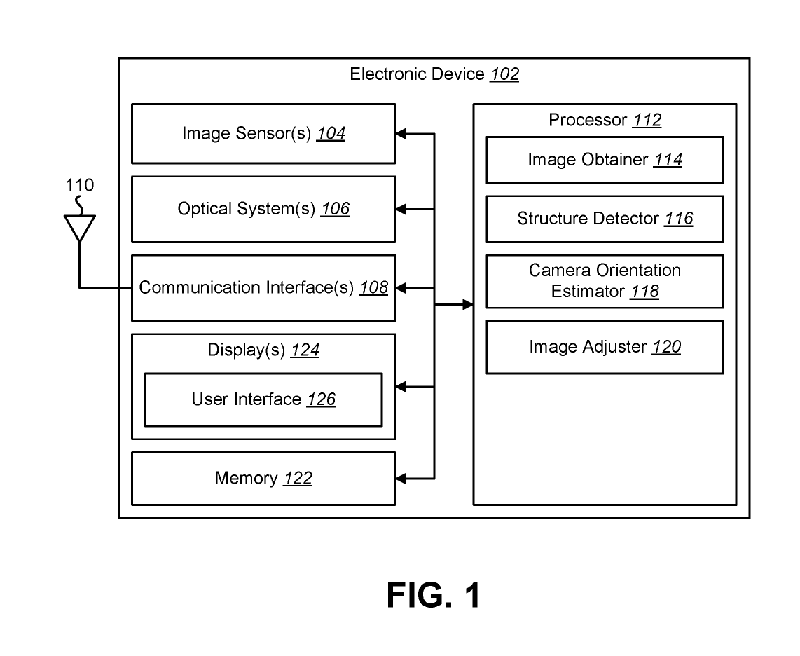

FIG. 1 is a block diagram illustrating one example of an electronic device 102 in which systems and methods for adjusting (e.g., straightening) an image may be implemented. Examples of the electronic device 102 include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, appliances, etc. The electronic device 102 may include one or more components or elements. One or more of the components or elements may be implemented in hardware (e.g., circuitry), a combination of hardware and firmware, and/or a combination of hardware and software (e.g., a processor with instructions).

In some configurations, the electronic device 102 may perform one or more of the functions, procedures, methods, steps, etc., described in connection with one or more of FIGS. 1-15. Additionally or alternatively, the electronic device 102 may include one or more of the structures described in connection with one or more of FIGS. 1-15.

In some configurations, the electronic device 102 may include a processor 112, a memory 122, a display 124, one or more image sensors 104, one or more optical systems 106, and/or one or more communication interfaces 108. The processor 112 may be coupled to (e.g., in electronic communication with) the memory 122, display 124, image sensor(s) 104, optical system(s) 106, and/or communication interface(s) 108. It should be noted that one or more of the elements of the electronic device 102 described in connection with FIG. 1 (e.g., image sensor(s) 104, optical system(s) 106, communication interface(s) 108, display(s) 124, etc.), may be optional and/or may not be included (e.g., implemented) in the electronic device 102 in some configurations.

The processor 112 may be a general-purpose single- or multi-chip microprocessor (e.g., an Advanced RISC (reduced instruction set computing) Machine (ARM)), a special-purpose microprocessor (e.g., a digital signal processor (DSP)), a microcontroller, a programmable gate array, etc. The processor 112 may be referred to as a central processing unit (CPU). Although the processor 112 is shown in the electronic device 102, in an alternative configuration, a combination of processors (e.g., an image signal processor (ISP) and an application processor, an ARM and a digital signal processor (DSP), etc.) could be used. The processor 112 may be configured to implement one or more of the methods disclosed herein. The processor 112 may include and/or implement an image obtainer 114, a structure detector 116, a camera orientation estimator 118, and/or an image adjuster 120. It should be noted that one or more of the image obtainer 114, structure detector 116, camera orientation estimator 118, and/or image adjuster 120 may not be implemented in some configurations.

The memory 122 may be any electronic component capable of storing electronic information. For example, the memory 122 may be implemented as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 122 may store instructions and/or data. The processor 112 may access (e.g., read from and/or write to) the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112 and/or various pieces of data may be loaded onto the processor 112. Examples of instructions and/or data that may be stored by the memory 122 may include image data, image obtainer 114 instructions, structure detector 116 instructions, camera orientation estimator 118 instructions, and/or image adjuster 120 instructions, etc.

The communication interface(s) 108 may enable the electronic device 102 to communicate with one or more other electronic devices. For example, the communication interface(s) 108 may provide one or more interfaces for wired and/or wireless communications. In some configurations, the communication interface(s) 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface and yet another communication interface 108 may be a wireless local area network (WLAN) interface (e.g., Institute of Electrical and Electronics Engineers (IEEE) 802.11 interface). In some configurations, the communication interface 108 may send information (e.g., image information, line segment information, vanishing point information, focal length information, image adjustment (e.g., rotation, transformation, etc.) information, etc.) to and/or receive information from another device (e.g., a vehicle, a smart phone, a camera, a display, a remote server, etc.).

The electronic device 102 (e.g., image obtainer 114) may obtain one or more images (e.g., digital images, image frames, frames, video, captured images, etc.). For example, the electronic device 102 may include the image sensor(s) 104 and the optical system(s) 106 (e.g., lenses) that focus images of scene(s) and/or object(s) that are located within the field of view of the optical system 106 onto the image sensor 104. The optical system(s) 106 may be coupled to and/or controlled by the processor 112 in some configurations. A camera (e.g., a visual spectrum camera or otherwise) may include at least one image sensor and at least one optical system. Accordingly, the electronic device 102 may be one or more cameras and/or may include one or more cameras in some implementations. In some configurations, the image sensor(s) 104 may capture the one or more images (e.g., image frames, video, still images, burst mode images, captured images, etc.).

Additionally or alternatively, the electronic device 102 (e.g., image obtainer 114) may request and/or receive the one or more images from another device (e.g., one or more external cameras coupled to the electronic device 102, a network server, traffic camera(s), drop camera(s), vehicle camera(s), web camera(s), etc.). In some configurations, the electronic device 102 may request and/or receive the one or more images (e.g., captured images) via the communication interface 108. For example, the electronic device 102 may or may not include camera(s) (e.g., image sensor(s) 104 and/or optical system(s) 106) and may receive images from one or more remote device(s). One or more of the images (e.g., image frames) may include one or more scene(s) and/or one or more object(s).

In some configurations, the electronic device 102 may include an image data buffer (not shown). The image data buffer may be included in the memory 122 in some configurations. The image data buffer may buffer (e.g., store) image data from the image sensor(s) 104 and/or external camera(s). The buffered image data may be provided to the processor 112.

The display(s) 124 may be integrated into the electronic device 102 and/or may be coupled to the electronic device 102. Examples of the display(s) 124 include liquid crystal display (LCD) screens, light emitting display (LED) screens, organic light emitting display (OLED) screens, plasma screens, cathode ray tube (CRT) screens, etc. In some implementations, the electronic device 102 may be a smartphone with an integrated display. In another example, the electronic device 102 may be coupled to one or more remote displays 124 and/or to one or more remote devices that include one or more displays 124.

In some configurations, the electronic device 102 may include a camera software application. When the camera application is running, images of objects that are located within the field of view of the optical system(s) 106 may be captured by the image sensor(s) 104. The images that are being captured by the image sensor(s) 104 may be presented on the display 124. For example, one or more images may be sent to the display(s) 124 for viewing by a user. In some configurations, these images may be played back from the memory 122, which may include image data of an earlier captured scene. The one or more images obtained by the electronic device 102 may be one or more video frames and/or one or more still images. In some configurations, the display(s) 124 may present a perspective-adjusted image (e.g., straightened image) result from the processor 112 (e.g., from the image adjuster 120) and/or from the memory 122.

In some configurations, the electronic device 102 may present a user interface 126 on the display 124. For example, the user interface 126 may enable a user to interact with the electronic device 102. In some configurations, the user interface 126 may enable a user to interact with the electronic device 102. For example, the user interface 126 may receive a touch, a mouse click, a gesture, and/or some other indication that indicates an input (e.g., a command to capture an image, a command to adjust or straighten an image, etc.). It should be noted that a command to adjust (e.g., straighten) an image may or may not include information that specifies a transform parameter (e.g., a degree of rotation, etc.). For example, the command to adjust the image may indicate that a particular image should be adjusted, but may not specify a degree of adjustment (which may be determined automatically in accordance with some configurations of the systems and methods disclosed herein).

The electronic device 102 (e.g., processor 112) may optionally be coupled to, be part of (e.g., be integrated into), include and/or implement one or more kinds of devices. For example, the electronic device 102 may be implemented in a vehicle or a drone equipped with cameras. In another example, the electronic device 102 (e.g., processor 112) may be implemented in an action camera.

The processor 112 may include and/or implement an image obtainer 114. One or more images (e.g., image frames, video, burst shots, captured images, test images, etc.) may be provided to the image obtainer 114. For example, the image obtainer 114 may obtain image frames from one or more image sensors 104. For instance, the image obtainer 114 may receive image data from one or more image sensors 104 and/or from one or more external cameras. As described above, the image(s) (e.g., captured images) may be captured from the image sensor(s) 104 included in the electronic device 102 or may be captured from one or more remote camera(s).

In some configurations, the image obtainer 114 may request and/or receive one or more images (e.g., image frames, etc.). For example, the image obtainer 114 may request and/or receive one or more images from a remote device (e.g., external camera(s), remote server, remote electronic device, etc.) via the communication interface 108.

One or more images obtained by the image obtainer 114 may include a scene and/or object(s) for adjusting (e.g., adjusting the perspective of, straightening, etc.). Adjusting an image may include changing the perspective (e.g., camera perspective) of the image. For example, the processor 112 may utilize the image adjuster 120 to straighten the image (e.g., the scene and/or one or more objects) in some configurations. Straightening the image may include changing the perspective (e.g., viewpoint) such that the perspective (e.g., camera angle) has 0 degree pitch, 0 degree roll (e.g., tilt), and/or 0 degree yaw with respect to the main structure in the scene (and/or an object in the scene) of an image.

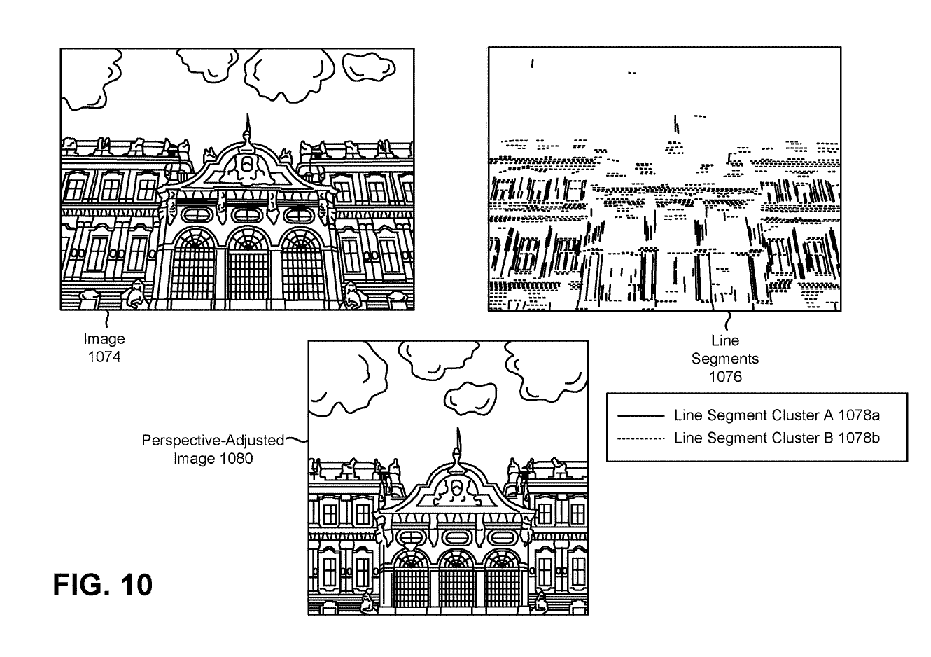

In some configurations, the processor 112 may include and/or implement a structure detector 116. The structure detector 116 may detect one or more lines (e.g., line segments) in the image. For example, the processor 112 may determine lines corresponding to a scene and/or objects (e.g., buildings) in the image using a probabilistic Hough transform and/or a line segment detector (LSD). Some examples of line segments are given in connection with FIGS. 10-14.

The structure detector 116 may detect one or more vanishing points corresponding to the lines (e.g., line segments). In some approaches, the structure detector 116 may generate vanishing point hypotheses by determining intersection points based on line segments (e.g., randomly selected line segments) and/or may cluster line segments to produce one or more vanishing points (e.g., a set of vanishing points). For example, each of the line segments may be represented with a variable (e.g., vector, set of values, Boolean set, etc.) that indicates which of the vanishing point hypotheses is/are consistent with the line segment. For instance, each line segment may be represented as a Boolean set. In some approaches, each Boolean value may indicate if the line segment is consistent with a vanishing point hypothesis (e.g., whether the line segment or an extension thereof intersects with the vanishing point hypothesis).

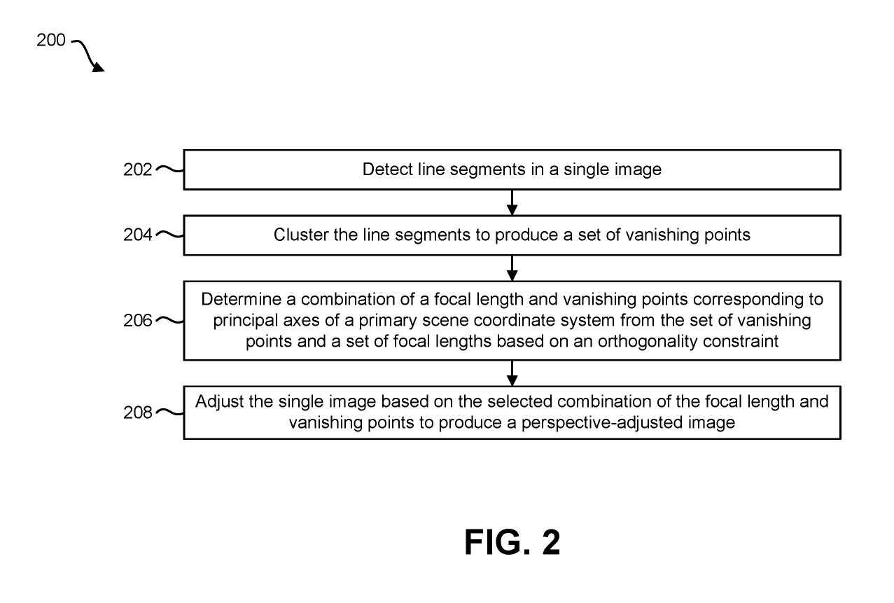

In some configurations, vanishing point detection may be performed via line segment clustering. Projections of parallel 3D lines may fall in the same cluster. The line segments may be clustered based on the similarity (or dissimilarity) between variables corresponding to the line segments. In some approaches, each cluster may correspond to one vanishing point. A cluster may be filtered out as an invalid vanishing point if the number of line segments in that cluster is less than a threshold. The vanishing point coordinate for each line segment cluster may be refined by minimizing the sum of the squared distances between the vanishing point and all line segments in the cluster. Examples of approaches for detecting vanishing points are given in connection with FIGS. 2-7.

The processor 112 may include and/or implement a camera orientation estimator 118. The camera orientation estimator 118 may estimate the orientation (e.g., rotation) of the camera that captured an image. For example, the camera orientation estimator 118 may estimate a perspective from which the image was captured.

In some configurations, the camera orientation estimator 118 may determine (e.g., select) a combination of a focal length and vanishing points corresponding to principal axes (e.g., x, y and z axes) of the primary scene coordinate system. The combination of focal length and vanishing points may be determined (e.g., selected) from a set of detected vanishing points (e.g., set of valid vanishing points) and/or a set of focal lengths based on an orthogonality constraint. Multiple combinations of focal length and vanishing points that satisfy the orthogonality constraint may exist. The camera orientation estimator 118 may select the combination with the largest number of corresponding (e.g., supporting) line segments.

In some configurations, the orthogonality constraint may be accomplished (e.g., satisfied, achieved, etc.) in accordance with Equations (1) and (2). Equation (1) may express a camera projection (which may be utilized to compute the projection of any infinity point along a 3D direction on the 2D image plane, for example).

vᵢ=KRpᵢ (1)

In Equation (1), vᵢ is a homogenous vanishing point coordinate (which may include three dimensions (e.g., a 3×1 vector)), K is a camera intrinsic matrix (which may include the focal length and optical center, for example), R is a camera rotation matrix, and pᵢ is a vector indicating a 3D direction. In Equation (1), for instance, the infinity point along a 3D direction represented by pᵢ may be rotated by the rotation matrix (which may have 3×3 dimensions, for example) to align the coordinate system of the 3D space with the coordinate system of the camera. The result of the rotation may be a 3x1 vector, which may represent the coordinate values of the 3D infinity point in the coordinate system of the camera. The 3D infinity point may be projected by multiplying by the camera intrinsic matrix (e.g., a projection matrix) to compute the 2D coordinate value on the image plane. If pᵢ represents the directions of the principal axes (e.g., p₀=[1, 0, 0]^{T}, p₁=[0,1,0]^{T}, and p₂=[0, 0, 1]^{T}, then Rpᵢ represents a column of the camera rotation matrix R. The orthogonality constraint may be expressed by Equation (2) given the fact that different columns in a rotation matrix should be orthogonal to each other.

K⁻¹vᵢ⊥K⁻¹vⱼ→(xᵢ−cₓ)(xᵢ−cₓ)+(yᵢ−c_{y})(yⱼ−c_{y})+f²=0 (2)

In Equation (2), x is a horizontal component of a vanishing point coordinate, y is a vertical component of a vanishing point coordinate, f is the focal length, cₓ is the optical center in the horizontal direction, c_{y} is the optical center in the vertical direction, i is an index for a first vanishing point corresponding to one principal axis direction, and j is an index for a second vanishing point corresponding to another principal axis direction.

In some configurations, the camera intrinsic matrix may be unknown without calibration. In some cases where the camera intrinsic matrix is unknown, a centered optical center may be assumed. For example, the camera orientation estimator 118 may assume and/or determine a center point of an image. In some configurations, the camera orientation estimator 118 may determine the center point based on the dimensions and/or size of the image. The camera orientation estimator 118 may evaluate (e.g., try) possible focal length values (that are uniformly sampled, for example) within a canonical range. The canonical range may also be determined based on the dimensions and/or size of the image. The camera orientation estimator 118 may check every combination of a focal length sampled from this canonical range and a set (e.g. triplet or pair) of vanishing points to see if they satisfy the orthogonality constraint in Equation (2).

The camera orientation estimator 118 may refine the focal length estimation once the set of vanishing points corresponding to the principal axes of the scene has been selected. In some configurations, if there are two finite vanishing points, estimating the focal length may be accomplished in accordance with Equation (2) by assuming f is an unknown variable. If there is a smaller number than two finite vanishing points, a focal point of f=0.8*image_width may be used. It should be noted that a different factor than 0.8 may be utilized in some configurations.

The camera orientation estimator 118 may estimate a rotation matrix. For example, the camera orientation estimator 118 may obtain columns of the rotation matrix from the vanishing points. The rotation matrix may be expressed in accordance with Equation (3).

r_{{i, j, k}}=K⁻¹v_{{i, j, k}} (3)

In Equation (3), rᵢ, rⱼ, and rₖ are three columns of the rotation matrix. If only two vanishing points are detected, then the third column of the rotation matrix may be the cross product of the other two columns. The camera orientation estimator 118 may determine the permutation of the columns such that the constructed rotation matrix has a determinant of 1 and the minimum rotation angle (of the permutations, for example). The rotation angle may be computed as the norm of the axis-angle representation of the rotation matrix constructed by the three columns. Examples of approaches for estimating a 3D camera orientation and/or determining a combination of a focal length and vanishing points are given in connection with FIGS. 2-4 and 8.

The processor 112 may include and/or implement an image adjuster 120. The image adjuster 120 may adjust the image to produce a perspective-adjusted image (e.g., straightened image). For example, the image adjuster 120 may adjust the image based on the selected combination of the focal length and vanishing points to produce a perspective-adjusted image. In some configurations, the image adjuster 120 may adjust the image based on the rotation matrix. For example, the image adjuster 120 may determine an adjustment homography based on the rotation matrix and the estimated focal length. The image adjuster 120 may apply the adjustment homography to the image to produce the perspective-adjusted image. In some configurations, the image adjuster 120 may crop, shift, and/or resize (e.g., scale) the image (e.g., the perspective-adjusted image). Examples of approaches for adjusting an image are given in connection with FIGS. 2-4 and 8-9.

It should be noted that one or more of the elements or components of the electronic device 102 may be combined and/or divided. For example, the image obtainer 114, the structure detector 116, the camera orientation estimator 118, and/or the image adjuster 120 may be combined. Additionally or alternatively, one or more of the image obtainer 114, the structure detector 116, the camera orientation estimator 118, and/or the image adjuster 120 may be divided into elements or components that perform a subset of the operations thereof.

It should be noted that the systems and methods disclosed herein may not utilize a complex optimization problem approach and/or may not utilize a gradient descent approach for determining structure(s), for selecting focal length(s), for determining vanishing point(s), for estimating a camera orientation, and/or for determining an image perspective in some configurations. For example, the complex optimization problem approach and/or the gradient descent approaches may be relatively slow, processing intensive, and/or may utilize high power consumption. In contrast, some configurations of the systems and methods disclosed herein may operate more quickly and/or efficiently. This may enable image adjustment (e.g., straightening) to be performed on platforms with more constraints on processing power and/or energy consumption (e.g., mobile devices).

FIG. 2 is a flow diagram illustrating one configuration of a method 200 for adjusting an image. The method 200 may be performed by an electronic device (e.g., the electronic device 102 described in connection with FIG. 1).

The electronic device 102 may detect 202 line segments in a single image. This may be accomplished as described in connection with FIG. 1. For example, the electronic device 102 may detect one or more lines corresponding to a scene and/or object(s) (e.g., a building, shelves, furniture, etc.).

The electronic device 102 may cluster 204 the line segments to produce a set of vanishing points (e.g., set of valid vanishing points). This may be accomplished as described in connection with one or more of FIGS. 1 and 3-7. For example, the electronic device 102 may group line segments that correspond to (e.g., are consistent with) the same vanishing point(s) (e.g., one or more vanishing point hypotheses). In some configurations, each of the line segments and/or clusters of line segments may be represented with a variable (e.g., vector, set of values, Boolean set, etc.) that indicates which of the vanishing point hypotheses is/are consistent with the line segment(s). The line segments may be clustered based on the similarity (or dissimilarity) between variables corresponding to the line segments (e.g., clusters). For example, the electronic device 102 may initialize a cluster for each of the line segments and may iteratively merge the clusters. In some approaches, each of the clusters may be represented as and/or correspond to a Boolean set. Merging the clusters may include merging clusters corresponding to Booleans sets with an amount of similarity (e.g., greatest similarity or least dissimilarity, for example). In some configurations, the electronic device 102 may refine the coordinates of one or more vanishing points based on least-squares fitting.

The electronic device 102 may determine (e.g., select) 206 a combination of a focal length and vanishing points corresponding to principal axes of a primary scene coordinate system. The electronic device 102 may select the combination from the set of vanishing points (e.g., set of valid vanishing points) and a set of focal lengths based on an orthogonality constraint. This may be accomplished as described in connection with one or more of FIGS. 1, 3-4, and 8. Determining 206 the combination of a focal length and vanishing points may include selecting, from the set of vanishing points, a set of vanishing points with a largest number of corresponding line segments (e.g., supporting line segments) that satisfies the orthogonality constraint.

In some configurations, the electronic device 102 may evaluate possible focal length values (e.g., a set of focal lengths) within a canonical range. The electronic device 102 may optionally refine the focal length based on the selected vanishing points based on the orthogonality constraint. In some configurations, the focal length may be refined without concurrently updating the vanishing points. For example, the focal length may be refined based on vanishing points that are not updated with refining the focal length. This may be different from a complex optimization problem approach and/or a gradient descent approach, where vanishing points may be updated along with a focal length.

The electronic device 102 may estimate a three-dimensional (3D) camera orientation based on the selected vanishing points. Estimating the 3D camera orientation may include estimating a rotation matrix based on the vanishing points. For example, estimating the rotation matrix may include determining a permutation of rotation matrix columns that has a determinant of 1 and a minimum rotation angle (compared to the other permutations, for instance).

The electronic device 102 may adjust 208 the single image based on the selected combination of the focal length and vanishing points to produce a perspective-adjusted image (e.g., a straightened image). This may be accomplished as described in connection with one or more of FIGS. 1, 3-4, and 8-9. In some configurations, the electronic device 102 may present the perspective-adjusted image. For example, the electronic device 102 may present the perspective-adjusted image on a local display, on a remote display, and/or may send the perspective-adjusted image to another device for presentation. Additionally or alternatively, the electronic device 102 may store the perspective-adjusted image and/or may send the perspective-adjusted image to another device for storage.

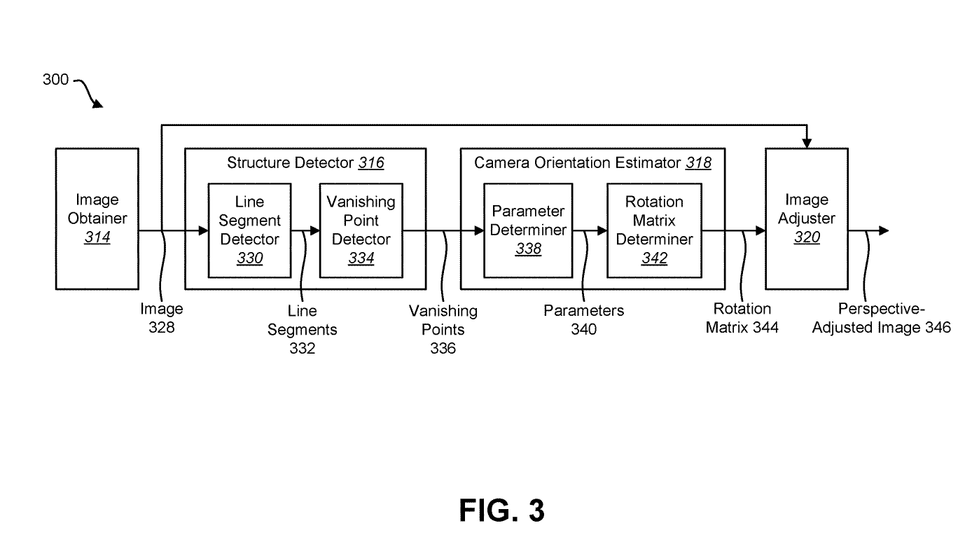

FIG. 3 is a block diagram illustrating examples of components and/or elements 300 that may be implemented in accordance with the systems and methods disclosed herein. As illustrated in FIG. 3, line segment detection may be performed based on an image 328 (e.g., an input image). Vanishing point detection may be performed based on detected line segment(s) 332. Camera orientation and focal length estimation may be performed based on the detected vanishing points 336. Image adjustment (e.g., correction) may be performed based on camera orientation and focal length estimation (e.g., a rotation matrix 344) to provide a perspective-adjusted image 346 (e.g., straightened image, etc.).

One or more of the components and/or elements 300 illustrated in FIG. 3 may be implemented in the electronic device 102 described in connection with FIG. 1. Additionally or alternatively, one or more of the functions and/or procedures described in connection with FIG. 3 may be performed by the electronic device 102 described in connection with FIG. 1. For example, one or more of the image obtainer 314, structure detector 316, camera orientation estimator 318, and/or image adjuster 320 may be examples of one or more corresponding components described in connection with FIG. 1.

The image obtainer 314 may obtain an image 328 as described in connection with FIG. 1. For example, the image obtainer 314 may obtain an image 328 from a camera included in an electronic device (e.g., electronic device 102), may obtain an image 328 from a camera coupled to the electronic device (e.g., electronic device 102), and/or may obtain an image 328 from a remote device (via a communications interface, for example). The image 328 may be provided to the structure detector 316.

The structure detector 316 may include a line segment detector 330 and a vanishing point detector 334. For example, line segment detection and vanishing point detection may be performed by the structure detector 116 described in connection with FIG. 1. The line segment detector 330 may detect line segments in the image 328. This may be accomplished as described in connection with one or more of FIGS. 1, 2, and 4. The line segments 332 may be provided to the vanishing point detector 334.

The vanishing point detector 334 may detect vanishing points 336 based on the line segments. In some configurations, the vanishing point detector 334 may determine one or more vanishing point hypotheses by determining one or more intersections based on the line segments 332 (e.g., randomly selected line segments). For example, the vanishing point detector 334 may determine intersections between two line segments 332 and/or extensions of line segments 332 in a randomly selected pair of line segments. For instance, the line segments 332 may not intersect within image 328 bounds. Accordingly, the vanishing point detector 334 may determine where extensions of line segments 332 intersect. The location(s) of the one or more intersections may be vanishing point hypotheses.

The vanishing point detector 334 may cluster the line segments to produce a set of vanishing points 336. This may be accomplished as described in connection with one or more of FIGS. 1, 2, and 4-7. For example, the vanishing point detector 334 may initialize a cluster for each of the line segments and may iteratively merge the clusters. In some approaches, each of the clusters may be represented as and/or correspond to a Boolean set. For example, the vanishing point detector 334 may produce a Boolean set for each line segment, where each Boolean value of the Boolean set indicates whether the line segment is consistent with a vanishing point hypothesis. The vanishing point detector 334 may iteratively merge clusters corresponding to most similar (e.g., least dissimilar) Boolean sets. The set of vanishing points 336 may be provided to the camera orientation estimator 318.

The camera orientation estimator 318 may include a parameter determiner 338 and a rotation matrix determiner 342. For example, parameter determination and rotation matrix determination (e.g., camera orientation and focal length estimation) may be performed by the camera orientation estimator 118 described in connection with FIG. 1. The parameter determiner 338 may determine a combination of a focal length and vanishing points corresponding to principal axes of a primary scene coordinate system from the set of vanishing points 336 and a set of focal lengths based on an orthogonality constraint. This may be accomplished as described in connection with one or more of FIGS. 1, 2, 4, and 8. For example, the parameter determiner 338 may select, from the set of vanishing points 336, a set of vanishing points with a largest number of corresponding (e.g., supporting) line segments that satisfies the orthogonality constraint. The parameter determiner 338 may also determine (e.g., select) a focal length based on a number of finite vanishing points. The parameters 340 (e.g., the selected vanishing points and focal length) may be provided to the rotation matrix determiner 342.

The rotation matrix determiner 342 may determine a rotation matrix 344 based on the parameters 340 (e.g., the set of vanishing points and/or the focal length).

This may be accomplished as described in connection with one or more of FIGS. 1, 2, 4, and 8. For example, the rotation matrix determiner 342 may obtain components (e.g., columns) of the rotation matrix from the vanishing points (e.g., the selected vanishing points). The rotation matrix determiner 342 may determine a permutation of the components (e.g., columns) that has a determinant of 1 and a minimum rotation angle. The rotation matrix 344 may be provided to the image adjuster 320.

The image adjuster 320 may adjust the image 328 based on the rotation matrix 344 to produce a perspective-adjusted image 346. This may be accomplished as described in connection with one or more of FIGS. 1, 2, 4, 8, and 9. For example, the image adjuster 320 may determine an adjustment homography based on the rotation matrix and the focal length. The image adjuster 320 may apply the adjustment homography to the image 328 to produce the perspective-adjusted image 346. In some configurations, the image adjuster 320 may crop, shift, and/or resize (e.g., scale) the perspective adjusted image 346.

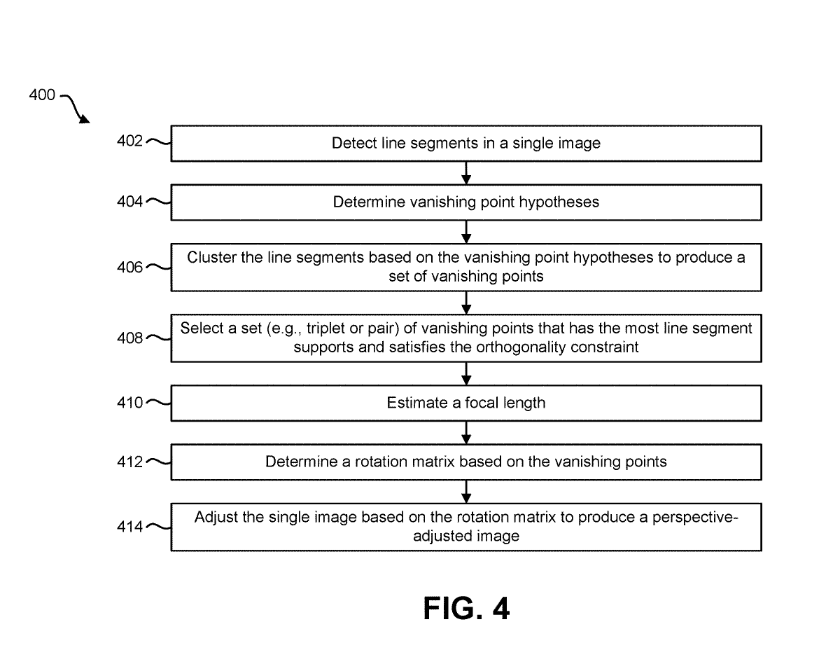

FIG. 4 is a flow diagram illustrating a more specific configuration of a method 400 for adjusting an image. The method 400 may be performed by an electronic device (e.g., the electronic device 102 described in connection with FIG. 1) and/or by the components and/or elements 300 described in connection with FIG. 3.

The electronic device 102 may detect 402 line segments in a single image. This may be accomplished as described in connection with one or more of FIGS. 1-3.

The electronic device 102 may determine 404 vanishing point hypotheses. This may be accomplished as described in connection with one or more of FIGS. 1 and 3. For example, the electronic device 102 may determine 404 the vanishing point hypotheses by determining intersecting points based on the line segments. In particular, a vanishing point (VP) may be located at an intersection of the projections of parallel lines in 3D space. For example, lines in the image may be obtained by line segment detection 402. Projections of lines in 3D space are lines in the image. Accordingly, the vanishing point hypotheses may be located at the intersection of the line segments (e.g., extensions of line segments) in the image.

The electronic device 102 may cluster 406 the line segments based on the vanishing point hypotheses to produce a set of vanishing points (e.g., set of valid vanishing points). This may be accomplished as described in connection with one or more of FIGS. 1-3 and 5-7. For example, the electronic device 102 may initialize a cluster for each of the line segments and may iteratively merge the clusters. In some approaches, each of the clusters may be represented as and/or correspond to a Boolean set. Merging the clusters may include merging clusters corresponding to Boolean sets with a smallest Jaccard distance. In some configurations, the electronic device 102 may refine the coordinates of one or more vanishing points (for each cluster, for example) based on least-squares fitting.

The electronic device 102 may select 408 a set of vanishing points (e.g., a triplet or pair of vanishing points) that has a largest number of corresponding line segments (e.g., the most line segment supports) and satisfies the orthogonality constraint. This may be accomplished as described in connection with one or more of FIGS. 1-3 and 8.

The electronic device 102 may estimate 410 a focal length. This may be accomplished as described in connection with one or more of FIGS. 1-3 and 8. For example, the electronic device may estimate 410 the focal length based on two finite vanishing points (in accordance with Equation (2), for instance) or may estimate 410 the focal length based on an image dimension (e.g., image width) if there are fewer than two finite vanishing points. In some configurations, the electronic device 102 may evaluate possible focal length values (e.g., a set of focal lengths) within a canonical range and/or may refine the focal length based on the selected vanishing points based on the orthogonality constraint.

The electronic device 102 may determine 412 a rotation matrix based on the vanishing points. This may be accomplished as described in connection with one or more of FIGS. 1-3 and 8. For example, determining 412 the rotation matrix may include determining a permutation of rotation matrix columns that has a determinant of 1 and a minimum rotation angle (compared to the other permutations, for instance).

The electronic device 102 may adjust 414 the single image based on the rotation matrix to produce a perspective-adjusted image (e.g., a straightened image). This may be accomplished as described in connection with one or more of FIGS. 1-3 and 8-9. In some configurations, the electronic device 102 may present the perspective-adjusted image. For example, the electronic device 102 may present the perspective-adjusted image on a local display, on a remote display, and/or may send the perspective-adjusted image to another device for presentation. Additionally or alternatively, the electronic device 102 may store the perspective-adjusted image and/or may send the perspective-adjusted image to another device for storage.

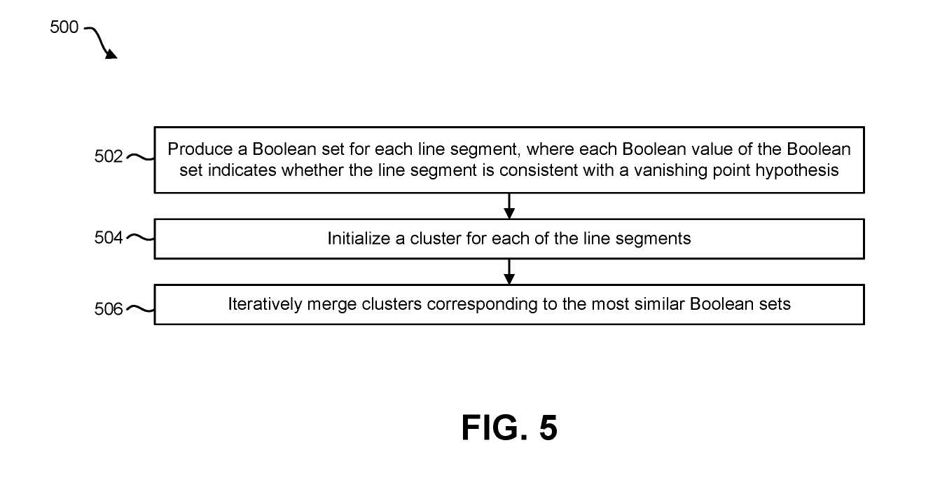

FIG. 5 is a flow diagram illustrating one configuration of a method 500 for clustering line segments. The electronic device 102 described in connection with FIG. 1 and/or one or more of the components and/or elements 300 (e.g., the vanishing point detector 334) described in connection with FIG. 3 may perform the method 500. The method 500 may be a more specific example of clustering 204, 406 the line segments as described in connection with one or more of FIGS. 2 and 4.

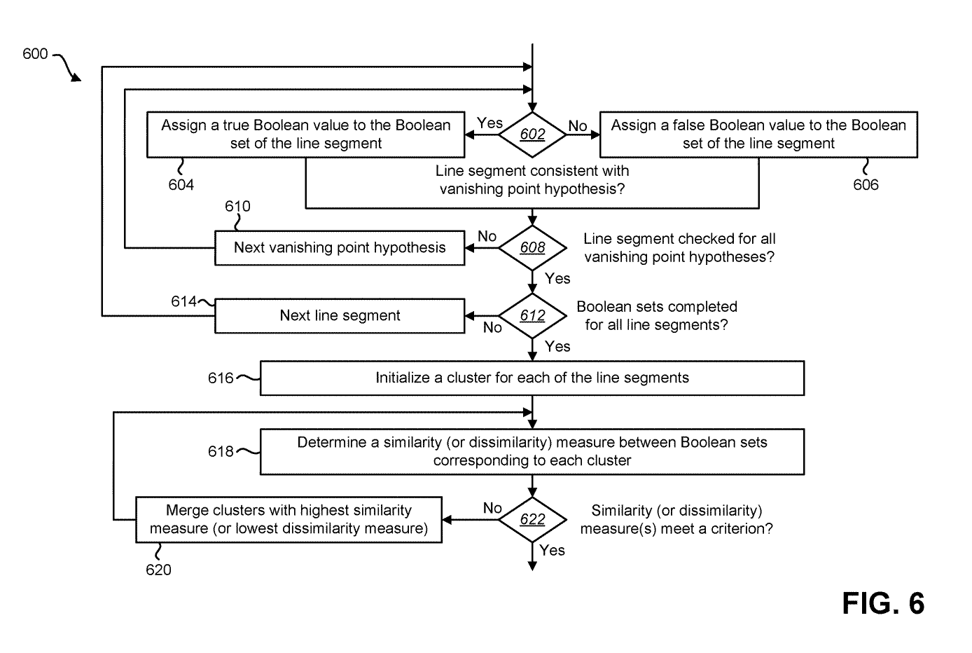

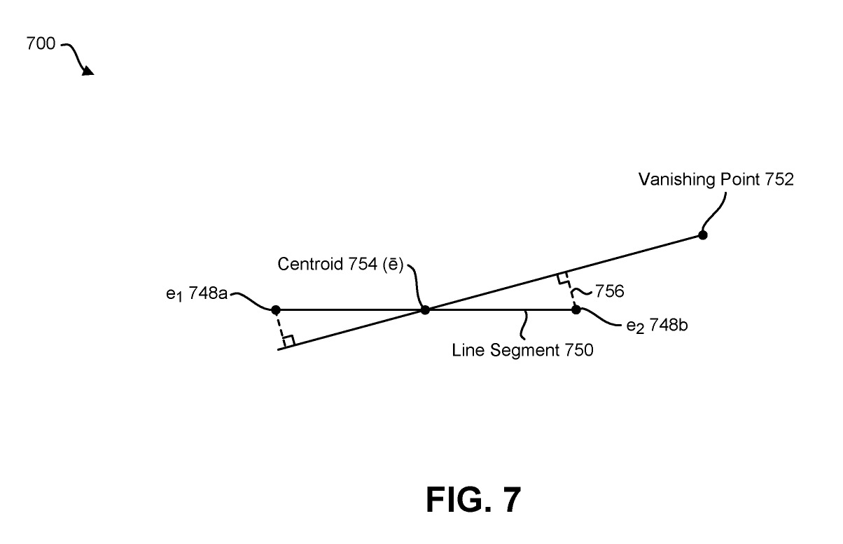

The electronic device 102 may produce 502 a Boolean set for each line segment. For example, the electronic device 102 may generate a set of values (e.g., bits, characters, variables, states, a string, an array, etc.) corresponding to each line segment. Each Boolean value of the Boolean set may indicate whether the corresponding line segment is consistent with a vanishing point hypothesis. For example, the electronic device 102 may determine whether each line segment is consistent with each vanishing point hypothesis. This may be accomplished as described in connection with one or more of FIGS. 6 and 7 in some configurations. Each Boolean value in the Boolean set may respectively correspond to each of the vanishing point hypotheses. The electronic device 102 may set one or more of the Boolean values to indicate whether a line segment is consistent with one or more vanishing points hypotheses.

The electronic device 102 may initialize 504 (e.g., create) a cluster for each of the line segments. For example, a cluster may be data (e.g., an object, a list, bits, an array, etc.) that indicates one or more line segments. A cluster may include one or more line segments. For example, a cluster may initially include only one line segment, but may be merged with one or more other clusters to include multiple line segments.

The electronic device 102 may iteratively merge 506 clusters corresponding to the most similar (e.g., least dissimilar) Boolean sets. For example, the electronic device 102 may determine a similarity (or dissimilarity) measure between Boolean sets corresponding to each cluster. For instance, the electronic device 102 may calculate the similarity (or dissimilarity) measure between pairs (e.g., all pairs) of the Boolean sets. In some approaches, the electronic device 102 may calculate the Jaccard index (as a similarity measure) or the Jaccard distance (as a dissimilarity measure) for each pair of Boolean sets.

The electronic device 102 may merge 506 the pair of clusters corresponding to the pair of Boolean sets that are the most similar (or least dissimilar) based on the similarity (or dissimilarity) measure. For example, the pair of clusters with the pair of most similar (or least dissimilar) Boolean sets may be merged 506 (e.g., joined) into one cluster. For instance, the line segment(s) for each of the clusters may be assigned to (e.g., placed into, moved to, added to, etc.) a single cluster. The Boolean set of the merged cluster may be computed as the intersection of the corresponding Boolean sets of the clusters before merging.

The electronic device 102 may then iterate the procedure by recalculating the similarity (or dissimilarity) measure between pairs of Boolean sets. In some approaches, the electronic device 102 may not recalculate the similarity (or dissimilarity) measure for pairs of Boolean sets for which the similarity (or dissimilarity) measure has already been calculated. For example, the electronic device 102 may recalculate the similarity (or dissimilarity) measure between the last merged cluster and each of the other clusters, but not for other (unchanged) cluster pairs for which the measure has already been calculated.

The procedure may iterate until an ending condition (e.g., a threshold) is met. For example, the clusters may be iteratively merged 506 until the similarity measure for the most similar Boolean sets is less than or equal to a threshold (or the dissimilarity measure for the least similar Boolean sets is greater than or equal to a threshold). Each of the resulting clusters may each correspond to vanishing point(s).

FIG. 6 is a flow diagram illustrating a more specific configuration of a method 600 for clustering line segments. The electronic device 102 described in connection with FIG. 1 and/or one or more of the components and/or elements 300 (e.g., the vanishing point detector 334) described in connection with FIG. 3 may perform the method 600. The method 600 may be a more specific example of clustering 204, 406 the line segments as described in connection with one or more of FIGS. 2, 4, and 5.

The electronic device 102 may determine 602 whether a line segment is consistent with a vanishing point hypothesis. For example, the electronic device 102 may determine 602 whether a line segment (and/or an extension of the line segment) is approximately aligned with the vanishing point hypothesis. In some configurations, the electronic device 102 may determine whether a centroid line of the line segment to the vanishing point hypothesis is within a threshold distance from a line segment endpoint. For example, the electronic device 102 may determine whether a line perpendicular to the centroid line to an endpoint of the line segment has a length that is less than or equal to a threshold distance. The line segment may be consistent with (e.g., approximately aligned with) the vanishing point hypothesis if the centroid line is within the threshold distance from the endpoint of the line segment. Otherwise, the line segment may be inconsistent. An example of determining whether a line segment is consistent with a vanishing point hypothesis is given in connection with FIG. 7.

In a case that the line segment is consistent with the vanishing point hypothesis, the electronic device 102 may assign 604 a true Boolean value to the Boolean set of the line segment. For example, the electronic device 102 may set to “true” a Boolean value corresponding to the vanishing point hypothesis.

In a case that the line segment is not consistent (e.g., is inconsistent) with the vanishing point hypothesis, the electronic device 102 may assign 606 a false Boolean value to the Boolean set of the line segment. For example, the electronic device 102 may set to “false” a Boolean value corresponding to the vanishing point hypothesis.

The electronic device 102 may determine 608 whether the line segment has been checked for all vanishing point hypotheses. If the line segment has not been checked for all vanishing point hypotheses, the electronic device 102 may proceed 610 to the next vanishing point hypothesis and determine 602 whether the line segment is consistent with the next vanishing point hypothesis.

If the line segment has been checked for all vanishing point hypotheses, the electronic device 102 may determine 612 whether Boolean sets have been completed for all line segments. If Boolean sets for all line segments have not been completed, the electronic device 102 may proceed 614 to the next line segment and determine 602 whether the next line segment is consistent with a vanishing point hypothesis.

If the Boolean sets are completed for all of the line segments, the electronic device 102 may initialize 616 (e.g., create) a cluster for each of the line segments. For example, each line segment may start in its own cluster. This may be accomplished as described in connection with FIG. 5. For instance, the electronic device 102 may instantiate a cluster for each of the line segments. Each cluster may initially include only one line segment, but may be merged with one or more other clusters to include multiple line segments.

The electronic device 102 may determine 618 a similarity (or dissimilarity) measure between Boolean sets corresponding to each cluster. One example of a dissimilarity measure between Boolean sets is a Jaccard distance. The electronic device 102 may determine 618 the Jaccard distance between each pair of Boolean sets. The Jaccard distance (d) of two Boolean sets (set A and set B) is given in Equation (4).

$${d}_{j} ( A , B ) = \frac{\vert A ⋃ B \vert - \vert A ⋂ B \vert}{\vert A ⋃ B \vert} \qquad ( 4 )$$

It should be noted that as some of the procedures of the method 600 may repeat (for each iteration, for example), the similarity (or dissimilarity) measure between pairs of Boolean sets may be recalculated. In some approaches, the electronic device 102 may not recalculate the similarity (or dissimilarity) measure for pairs of Boolean sets for which the similarity (or dissimilarity) measure has already been calculated.

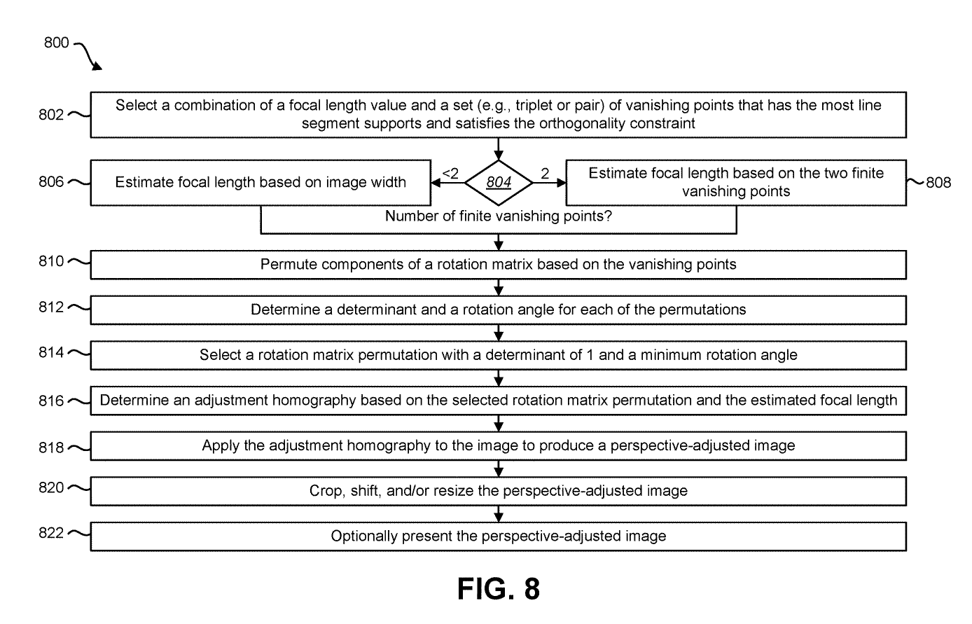

The electronic device 102 may determine 622 whether the similarity (or dissimilarity measure(s)) meet a criterion. For example, the electronic device 102 may determine whether an end condition has been reached based on the similarity (or dissimilarity measure(s). For instance, the electronic device 102 may determine 622 whether the lowest (e.g., smallest) Jaccard distance is 1. Alternatively, the electronic device 102 may determine whether the highest (e.g., largest) Jaccard index is 0. If the criterion is met, then the electronic device 102 may proceed to the next step (e.g., continue to one or more of the procedures described in connection with FIG. 8) and/or may complete (e.g., end) clustering.

If the similarity (or dissimilarity) measure(s) do not meet the criterion, the electronic device 102 may merge 620 clusters with the highest similarity measure (or lowest dissimilarity measure). This may be accomplished as described in connection with one or more of FIGS. 1, 2 and 5. For example, the electronic device 102 may merge 620 the pair of clusters corresponding to the pair of Boolean sets that are the most similar (or least dissimilar) based on the similarity (or dissimilarity) measure. For instance, the pair of clusters with the lowest Jaccard distance (or with the highest Jaccard index) may be merged 620.

As can be observed in connection with FIG. 6, the electronic device 102 may iteratively merge clusters. For example, clusters (represented with Boolean sets) with the smallest Jaccard distance may be iteratively merged. The procedure may stop when the smallest Jaccard distance is 1. Accordingly, one or more vanishing points may be detected with J-linkage clustering in some approaches.

In some configurations, the electronic device 102 may optionally refine the vanishing point corresponding to each cluster. For example, the coordinates of the vanishing point for each cluster may be refined by least-squares fitting.

FIG. 7 is a diagram illustrating an example of measuring consistency between a line segment 750 and a vanishing point 752 (e.g., vanishing point hypothesis). In particular, FIG. 7 illustrates a line segment 750 with endpoints 748a-b (e.g., e₁ 748a and e₂ 748b) and a centroid 754(ē). In some approaches, the electronic device 102 (e.g., structure detector 116, structure detector 316, vanishing point detector 334, etc.) may determine whether the line segment 750 is consistent with a vanishing point 752 (e.g., vanishing point hypothesis) based on a line from (e.g., through) the centroid 754 of the line segment 750 (e.g., a centroid line) to the vanishing point 752. For example, if a perpendicular distance 756 between an endpoint 748b of line segment and the centroid line is less than a threshold distance, the line segment 750 may be consistent with the vanishing point hypothesis. In some configurations, each Boolean value corresponding to a consistent vanishing point hypothesis may be set to “true” while each Boolean value corresponding to an inconsistent vanishing point hypothesis may be set to “false” as described in connection with FIG. 6.

FIG. 8 is a flow diagram illustrating one configuration of a method 800 for estimating a camera orientation and/or adjusting an image. The method 800 may be performed by the electronic device 102 described in connection with FIG. 1. For example, the method 800 may be performed by one or more of the camera orientation estimators 118, 318 and/or image adjusters 120, 320 described in connection with one or more of FIGS. 1 and 3.

The electronic device 102 may select 802 a combination of a focal length value and a set (e.g., a triplet or pair) of vanishing points that has the most line segment supports and satisfies the orthogonality constraint. This may be accomplished as described in connection with one or more of FIGS. 1-4. In some configurations, selecting 802 the combination of the focal length value and the set of vanishing points may include evaluating (e.g., trying) possible canonical focal length values.

The electronic device 102 may determine 804 a number of finite vanishing points. If the number of finite vanishing points is two, the electronic device 102 may estimate 808 the focal length based on the two finite vanishing points. This may be accomplished as described in connection with FIG. 1. For example, the electronic device 102 may estimate 808 the focal length in accordance with Equation (2). In some configurations, estimating 808 the focal length may include refining the focal length estimation. If the number of finite vanishing points is less than 2, the electronic device 102 may estimate 806 the focal length based on image width. This may be accomplished as described in connection with FIG. 1. For example, the electronic device 102 may estimate the focal length as f=factor*image_width. The factor may be 0.8 or another value.

The electronic device 102 may permute 810 components (e.g., columns, rows, etc.) based on the vanishing points. This may be accomplished as described in connection with one or more of FIGS. 1-4. For example, the electronic device 102 may obtain columns of the rotation matrix from the vanishing points. The electronic device 102 may permute 810 the components by reordering the components in each possible order. For example, with a column A, a column B, and a column C, the electronic device 102 may permute the columns in each possible order: ABC, ACB, BAC, CAB, BCA, and CBA.

The electronic device 102 may determine 812 a determinant and a rotation angle for each of the permutations. For example, the electronic device 102 compute the determinant for each of the permutations and may compute a rotation angle for each of the permutations.

The electronic device 102 may select 814 a rotation matrix permutation with a determinant of 1 and a minimum rotation angle. For example, the electronic device 102 may discard any permutations that do not have a determinant of 1. If there is more than 1 permutation with a determinant of 1, the electronic device 102 may compare the rotation angles of each of the remaining permutations. Of the remaining permutations, the electronic device 102 may select 814 the rotation matrix permutation that has the smallest rotation angle.

The electronic device 102 may determine 816 an adjustment homography based on the selected rotation matrix permutation. In some configurations, the electronic device 102 may determine 816 the adjustment homography in accordance with Equation (5).

H=KRK⁻¹ (5)

In Equation (5), H is the adjustment (e.g., correction) homography, K is the camera intrinsic matrix, and R is the camera rotation matrix (e.g., the camera orientation). For example, R may be the selected rotation matrix permutation and K may include the estimated focal length.

The electronic device 102 may apply 818 the adjustment homography to the image to produce a perspective-adjusted image. For example, the electronic device 102 may apply 818 the adjustment homography H to the image.

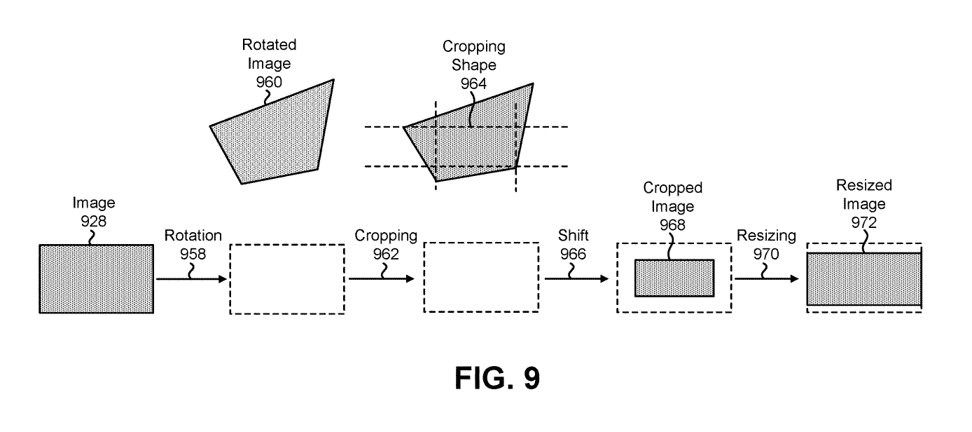

The electronic device 102 may crop, shift, and/or resize 820 the perspective-adjusted image. For example, the electronic device 102 may discard pixels that are outside of a rectangular viewing area. In some approaches, the electronic device 102 may determine a largest rectangular viewing area that fits within the perspective-adjusted image. In some approaches, the rectangular viewing area may maintain the size ratio of the original image. The electronic device 102 may shift (e.g., translate) the image pixels in order to center the image (e.g., cropped image). The electronic device 102 may resize (e.g., scale) the image (e.g., the cropped and/or shifted image). For example, the electronic device 102 may scale the image up as large as possible within the original image dimensions. An example of cropping, shifting, and/or resizing is given in connection with FIG. 9.

The electronic device 102 may optionally present 822 the perspective-adjusted image. This may be accomplished as described in connection with one or more of FIGS. 1, 2, and 4. For example, the electronic device 102 may present the perspective-adjusted image (with or without cropping, shifting, and/or resizing) on a local (e.g., integrated) display or a remote display.

FIG. 9 is a diagram illustrating examples of image adjustment functions (e.g., image correction, image straightening, etc.). The electronic device 102 described in connection with FIG. 1 (e.g., the image adjuster 120 and/or image adjuster 320) may perform one or more of the functions described in connection with FIG. 9.

As illustrated in FIG. 9, rotation 958 may be performed on the image 928 to produce a rotated image 960. The image rotation 958 may be performed based on the estimated camera orientation and the camera intrinsic matrix as described herein. For example, an adjustment homography may be applied to the image 928 in accordance with Equation (5). The image rotation may adjust the perspective of the image. For example, the image rotation may involve perspective correction (e.g., making scene look upright).

As illustrated in FIG. 9, rotating the image 928 may alter the shape of the image (e.g., may change the shape from a rectangle to some quadrilateral shape). In some configurations, cropping 962 may be applied to the image 928 (e.g., rotated image 960) in accordance with a cropping shape 964. For example, the rotated image 960 may be cropped to a particular cropping shape 964 (e.g., a rectangle or other shape).

In some configurations, a shift 966 (e.g., diagonal, vertical and/or horizontal shift(s)) may be applied to the image 928 (e.g., the image 928 with rotation 958 and/or cropping 962 applied). For example, the cropped image 968 may be shifted in order to center the cropped image 968.

Resizing 970 (e.g., scaling) may be applied to the image 928 (e.g., the image 928 with rotation 958, cropping 962, and/or shifting 966 applied) to produce a resized image 972 (e.g., scaled image). As can be observed in FIG. 9, the dimensional ratio of the cropped image 968 may be preserved when resizing 970 in some configurations. For example, the cropped image 968 may be scaled as large as possible within the original image dimensions in some approaches. Other approaches may be utilized (where the rotated image 960 is cropped to preserve the same dimensional ratio as the original image 928 and/or resized to fill the entire original image dimensions, for example, etc.). One or more of the operations described in connection with FIG. 9 may be performed in order to present the rotated image 960 with a similar size and/or shape as the original image 928.

FIG. 10 illustrates an example of image adjustment in accordance with the systems and methods disclosed herein. In particular, FIG. 10 illustrates an image 1074, line segments 1076 corresponding to the image 1074, and a perspective-adjusted image 1080. Each of the line segment clusters 1078a-b correspond to respective vanishing points in accordance with the systems and methods disclosed herein. As can be observed, the scene in the image appears straightened (e.g., upright).

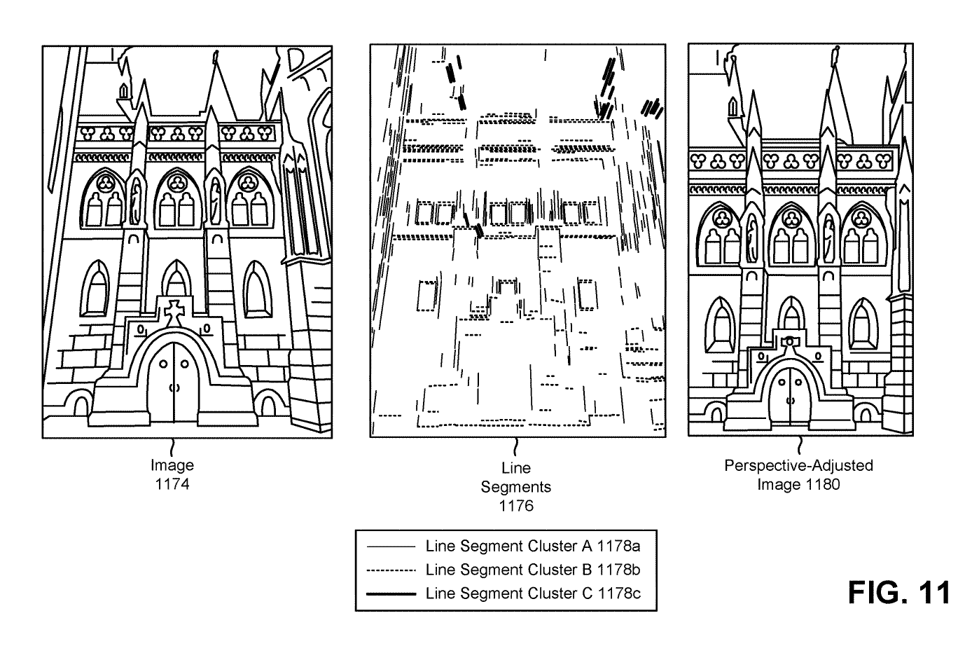

FIG. 11 illustrates another example of image adjustment in accordance with the systems and methods disclosed herein. In particular, FIG. 11 illustrates an image 1174, line segments 1176 corresponding to the image 1174, and a perspective-adjusted image 1180. Each of the line segment clusters 1178a-c correspond to respective vanishing points in accordance with the systems and methods disclosed herein. As can be observed, the scene in the image appears straightened (e.g., upright).

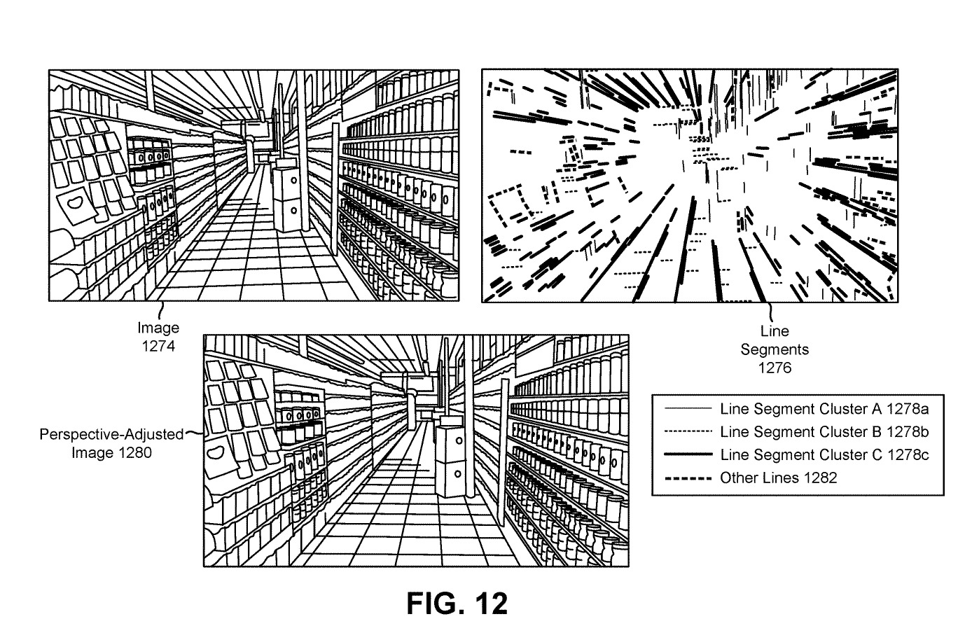

FIG. 12 illustrates another example of image adjustment in accordance with the systems and methods disclosed herein. In particular, FIG. 12 illustrates an image 1274, line segments 1276 corresponding to the image 1274, and a perspective-adjusted image 1280. Each of the line segment clusters 1278a-c correspond to respective vanishing points in accordance with the systems and methods disclosed herein. Other lines 1282 are also illustrated, which do not correspond to (valid) vanishing points. For example, the other lines 1282 may be inconsistent with vanishing point hypotheses. As can be observed, the scene in the image appears straightened (e.g., upright).

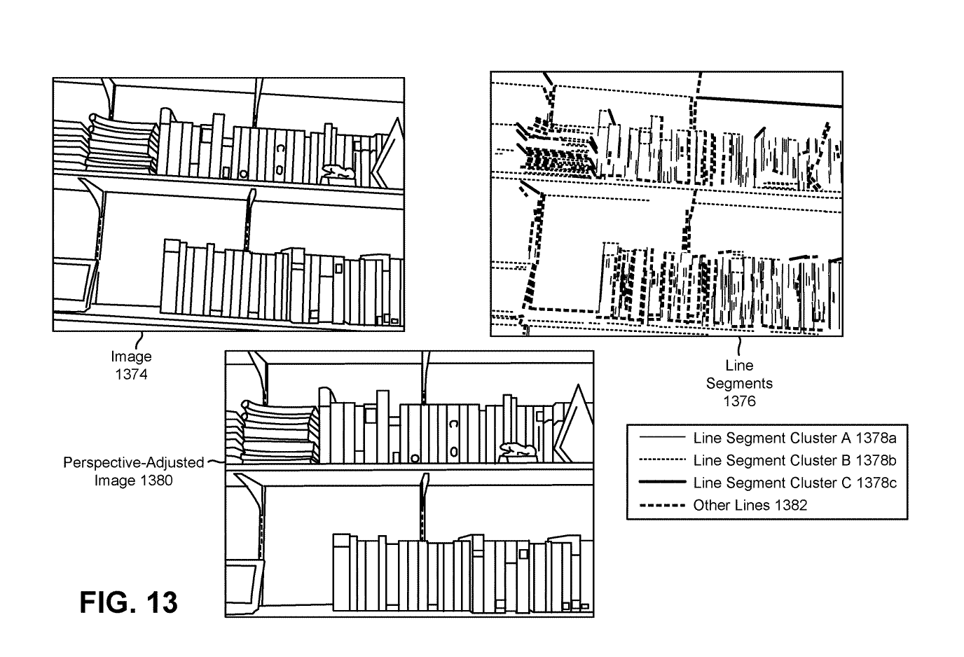

FIG. 13 illustrates another example of image adjustment in accordance with the systems and methods disclosed herein. In particular, FIG. 13 illustrates an image 1374, line segments 1376 corresponding to the image 1374, and a perspective-adjusted image 1380. Each of the line segment clusters 1378a-c correspond to respective vanishing points in accordance with the systems and methods disclosed herein. Other lines 1382 are also illustrated, which do not correspond to (valid) vanishing points. For example, the other lines 1382 may be inconsistent with vanishing point hypotheses. As can be observed, the scene in the image appears straightened (e.g., upright).

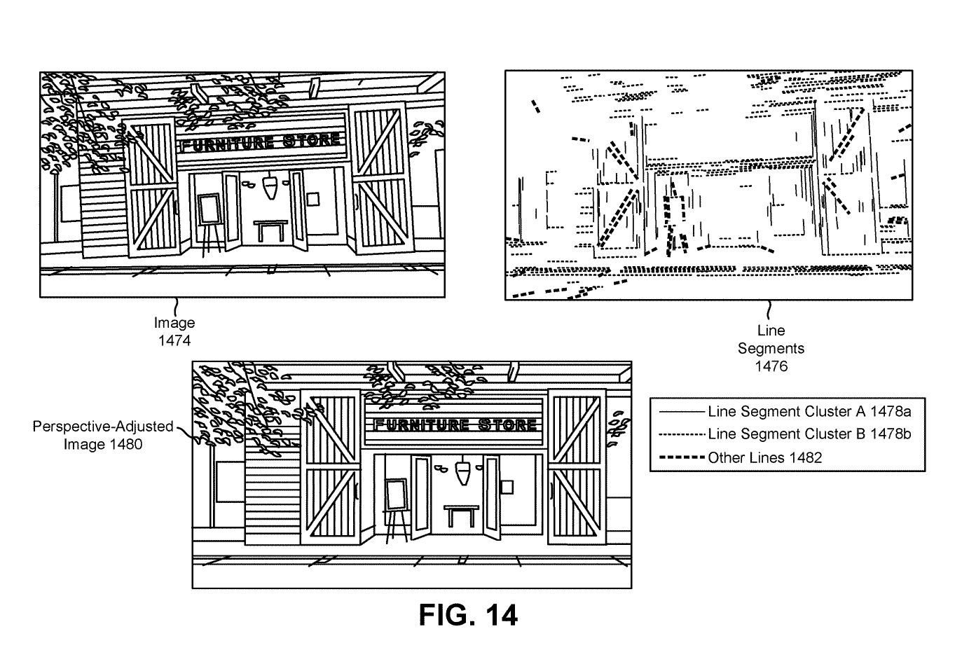

FIG. 14 illustrates another example of image adjustment in accordance with the systems and methods disclosed herein. In particular, FIG. 14 illustrates an image 1474, line segments 1476 corresponding to the image 1474, and a perspective-adjusted image 1480. Each of the line segment clusters 1478a-b correspond to respective vanishing points in accordance with the systems and methods disclosed herein. Other lines 1482 are also illustrated, which do not correspond to (valid) vanishing points. For example, the other lines 1482 may be inconsistent with vanishing point hypotheses. As can be observed, the scene in the image appears straightened (e.g., upright).

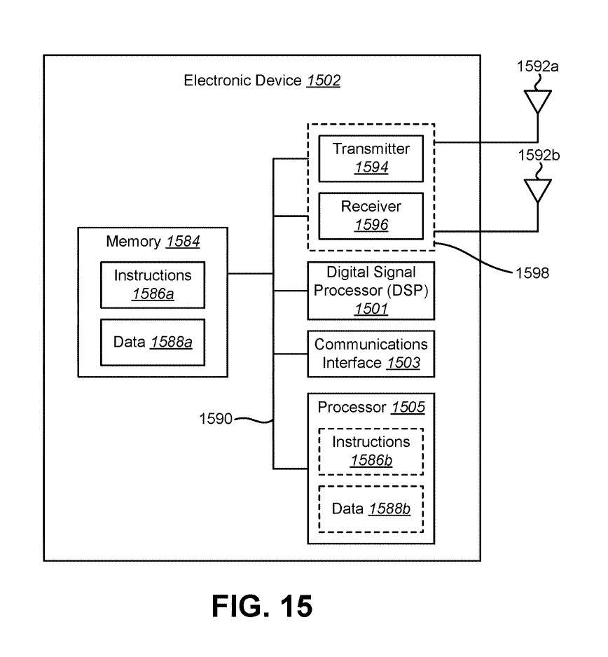

FIG. 15 illustrates certain components that may be included within an electronic device 1502 configured to implement various configurations of the systems and methods disclosed herein. The electronic device 1502 may be an access terminal, a mobile station, a user equipment (UE), a smartphone, a digital camera, a video camera, a tablet device, a laptop computer, a desktop computer, a server, etc. The electronic device 1502 may be implemented in accordance with the electronic device 102 described herein. The electronic device 1502 includes a processor 1505. The processor 1505 may be a general purpose single- or multi-chip microprocessor (e.g., an ARM), a special purpose microprocessor (e.g., a digital signal processor (DSP)), a microcontroller, a programmable gate array, etc. The processor 1505 may be referred to as a central processing unit (CPU). Although just a single processor 1505 is shown in the electronic device 1502, in an alternative configuration, a combination of processors (e.g., an ARM and DSP) could be implemented.

The electronic device 1502 also includes memory 1584. The memory 1584 may be any electronic component capable of storing electronic information. The memory 1584 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1588a and instructions 1586a may be stored in the memory 1584. The instructions 1586a may be executable by the processor 1505 to implement one or more of the methods described herein. Executing the instructions 1586a may involve the use of the data 1588a that is stored in the memory 1584. When the processor 1505 executes the instructions 1586, various portions of the instructions 1586b may be loaded onto the processor 1505 and/or various pieces of data 1588b may be loaded onto the processor 1505.

The electronic device 1502 may also include a transmitter 1594 and a receiver 1596 to allow transmission and reception of signals to and from the electronic device 1502. The transmitter 1594 and receiver 1596 may be collectively referred to as a transceiver 1598. One or more antennas 1592a-b may be electrically coupled to the transceiver 1598. The electronic device 1502 may also include (not shown) multiple transmitters, multiple receivers, multiple transceivers and/or additional antennas.

The electronic device 1502 may include a digital signal processor (DSP) 1501. The electronic device 1502 may also include a communications interface 1503. The communications interface 1503 may allow and/or enable one or more kinds of input and/or output. For example, the communications interface 1503 may include one or more ports and/or communication devices for linking other devices to the electronic device 1502. In some configurations, the communications interface 1503 may include the transmitter 1594, the receiver 1596, or both (e.g., the transceiver 1598). Additionally or alternatively, the communications interface 1503 may include one or more other interfaces (e.g., touchscreen, keypad, keyboard, microphone, camera, etc.). For example, the communication interface 1503 may enable a user to interact with the electronic device 1502.

The various components of the electronic device 1502 may be coupled together by one or more buses, which may include a power bus, a control signal bus, a status signal bus, a data bus, etc. For the sake of clarity, the various buses are illustrated in FIG. 15 as a bus system 1590.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for adjusting an image by an electronic device, the method comprising:
detecting line segments in a single image;
clustering the line segments to produce a set of vanishing points;
determining a combination of a focal length and vanishing points corresponding to principal axes of a primary scene coordinate system from the set of vanishing points and a set of focal lengths based on an orthogonality constraint; and
adjusting the single image based on the combination of the focal length and vanishing points to produce a perspective-adjusted image.

2. The method of claim 1, further comprising refining the focal length based on the determined vanishing points based on the orthogonality constraint.

3. The method of claim 1, wherein determining the combination of the focal length and vanishing points comprises selecting, from the set of vanishing points, a set of vanishing points with a largest number of corresponding line segments that satisfies the orthogonality constraint.

4. The method of claim 1, further comprising estimating a rotation matrix based on the determined vanishing points.

5. The method of claim 4, wherein estimating the rotation matrix comprises determining a permutation of rotation matrix columns that has a determinant of 1 and a minimum rotation angle.

6. The method of claim 1, wherein clustering the line segments comprises:
initializing a cluster for each of the line segments; and
iteratively merging the clusters.

7. The method of claim 6, wherein each of the clusters is represented as a Boolean set, and wherein merging the clusters comprises merging clusters with a smallest Jaccard distance.

8. The method of claim 1, further comprising refining coordinates of at least one vanishing point based on least-squares fitting.

9. The method of claim 1, wherein determining the combination of the focal length and vanishing points comprises evaluating possible focal length values within a canonical range.

10. An electronic device for adjusting an image, comprising:
a processor configured to:
detect line segments in a single image;
cluster the line segments to produce a set of vanishing points;
determine a combination of a focal length and vanishing points corresponding to principal axes of a primary scene coordinate system from the set of vanishing points and a set of focal lengths based on an orthogonality constraint; and
adjust the single image based on the combination of the focal length and vanishing points to produce a perspective-adjusted image.

11. The electronic device of claim 10, wherein the processor is further configured to refine the focal length based on the determined vanishing points based on the orthogonality constraint.

12. The electronic device of claim 10, wherein the processor is configured to determine the combination of the focal length and vanishing points by selecting, from the set of vanishing points, a set of vanishing points with a largest number of corresponding line segments that satisfies the orthogonality constraint.

13. The electronic device of claim 10, wherein the processor is further configured to estimate a rotation matrix based on the determined vanishing points.

14. The electronic device of claim 13, wherein the processor is configured to estimate the rotation matrix by determining a permutation of rotation matrix columns that has a determinant of 1 and a minimum rotation angle.

15. The electronic device of claim 10, wherein the processor is configured to cluster the line segments by:
initializing a cluster for each of the line segments; and
iteratively merging the clusters.

16. The electronic device of claim 15, wherein each of the clusters is represented as a Boolean set, and wherein the processor is configured to merge clusters with a smallest Jaccard distance.

17. The electronic device of claim 10, wherein the processor is further configured to refine coordinates of at least one vanishing point based on least-squares fitting.

18. The electronic device of claim 10, wherein the processor is configured to determine the combination of the focal length and vanishing points by evaluating possible focal length values within a canonical range.

19. An apparatus for adjusting an image, comprising:
means for detecting line segments in a single image;
means for clustering the line segments to produce a set of vanishing points;
means for determining a combination of a focal length and vanishing points corresponding to principal axes of a primary scene coordinate system from the set of vanishing points and a set of focal lengths based on an orthogonality constraint; and
means for adjusting the single image based on the combination of the focal length and vanishing points to produce a perspective-adjusted image.

20. The apparatus of claim 19, further comprising means for refining the focal length based on the determined vanishing points based on the orthogonality constraint.

21. The apparatus of claim 19, wherein the means for determining the combination of the focal length and vanishing points comprises means for selecting, from the set of vanishing points, a set of vanishing points with a largest number of corresponding line segments that satisfies the orthogonality constraint.

22. The apparatus of claim 19, wherein means for clustering the line segments comprises:
means for initializing a cluster for each of the line segments; and
means for iteratively merging the clusters.

23. The apparatus of claim 19, further comprising means for refining coordinates of at least one vanishing point based on least-squares fitting.

24. The apparatus of claim 19, wherein the means for determining the combination of the focal length and vanishing points comprises means for evaluating possible focal length values within a canonical range.

25. A computer-program product for adjusting an image, comprising a non-transitory computer-readable medium having instructions thereon, the instructions comprising:
code for causing an electronic device to detect line segments in a single image;
code for causing the electronic device to cluster the line segments to produce a set of vanishing points;
code for causing the electronic device to determine a combination of a focal length and vanishing points corresponding to principal axes of a primary scene coordinate system from the set of vanishing points and a set of focal lengths based on an orthogonality constraint; and
code for causing the electronic device to adjust the single image based on the combination of the focal length and vanishing points to produce a perspective-adjusted image.

26. The computer-program product of claim 25, further comprising code for causing the electronic device to refine the focal length based on the determined vanishing points based on the orthogonality constraint.

27. The computer-program product of claim 25, wherein the code for causing the electronic device to determine the combination of the focal length and vanishing points comprises code for causing the electronic device to select, from the set of vanishing points, a set of vanishing points with a largest number of corresponding line segments that satisfies the orthogonality constraint.

28. The computer-program product of claim 25, wherein the code for causing the electronic device to cluster the line segments comprises:
code for causing the electronic device to initialize a cluster for each of the line segments; and
code for causing the electronic device to iteratively merge the clusters.

29. The computer-program product of claim 25, further comprising code for causing the electronic device to refine coordinates of at least one vanishing point based on least-squares fitting.

30. The computer-program product of claim 25, wherein the code for causing the electronic device to determine the combination of the focal length and vanishing points comprises code for causing the electronic device to evaluate possible focal length values within a canonical range.
